(19) United States
(12) Patent Application Publication
(10) Pub. No.: US 2010/0181440 A1
(43) Pub. Date: Jul. 22, 2010

(54) Articulated Cable Management Systems and Methods For Use Thereof

(75) Inventors: Lars R. Larsen, Old Lyme, CT (US); Stewart A. Levesque, Scotland, CT (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignee: ORTRONICS, INC., New London, CT (US)

(21) Appl. No.: 12/356,563

(22) Filed: Jan. 21, 2009

(51) Int. Cl. F16L 3/22

(52) U.S. Cl. 248/68.1

(57) ABSTRACT

Systems and methods are provided for facilitating cable management. Thus, an extensible articulated arm is disclosed for stacking/organizing cables and cords in-line with an exhausting airflow. The articulated arm typically includes a series of pivotally connected elongated members. The articulated arm is generally mounted relative to a structure near an exhausting airflow. An elongated cable management conduit may be secured relative to each elongated member, such elongated cable management conduit generally defining an elongated channel adapted for receiving one or more cables/cords therethrough. Each elongated cable management conduit is typically configured such the width of the elongated cable management conduit is greater than its height. Thus, the cables/cords received through the elongated channel are arranged relative to a plane in-line with the exhausting airflow. This aerodynamic design enables the cable management conduits to act as airfoils in promoting efficient airflow of exhausting air around the articulated arm.

### BACKGROUND

1. Technical Field

The present disclosure relates to systems and methods for cable management. More particularly, the present disclosure relates to systems and methods for managing power and/or data communication cables and cords associated with a server.

2. Background Art

A major concern for housing and managing servers is the dissipation of heat produced thereby. More particularly, electrical and mechanical components of servers (and of CPUs in general) produce heat, which must be displaced to ensure the proper functioning of the components. For typical servers, as for most computing systems, heat is removed via fans which force hot air out of the rear of the server and/or server enclosure and draw cool air in. A frequently underestimated problem when designing servers is the disparity between the amount of heat generated and the cooling fan(s) capacity for removing such heat. This disparity is often amplified by the insulating effect that power cords and various other cables associated with a server can have on the server/enclosure. More particularly, such power cords and other cables block the flow of air in and out of the rear of the sever/enclosure, potentially trapping an excess amount of heat inside. Indeed, proper cable management is essential to the well-being and functionality of a server. Thus, systems and methods are needed for providing such proper cable management and effecting and/or facilitating efficient heat dissipation

Furthermore, a server must often be removed from within a server enclosure, e.g., for maintenance/diagnostic purposes, to access the back panel of the server, etc. It is generally essential for various purposes that the server remain plugged in and operational during such removal. Thus, the power cables and other cords associated with the server must have the ability to extend out from the enclosure along with the server. This requirement has the added disadvantage of complicating cable management as related to the cooling of the server/enclosure. More particularly, the added bulk of cables and cords needed to extend the server out of the enclosure makes efficient space management for such cables and cords a problem. Furthermore, in conventional cable management systems, the cables and cords generally require reorganization each time the server is removed from or returned to the enclosure. Thus, systems and methods are needed that facilitate quick and efficient organization of a large bulk of cables and cords, e.g., from a compact position to an extended position and vice versa.

Some conventional cable management systems, such as the HP Cable Management Ann 1U for DL360 G4 DIL140 G2 or the APC Cable Management Arm (AR8129) employ an articulating arm to manage the extension and retraction of cables from within a cabinet enclosure. The cables are typically held in place relative to the articulating members of the arm using a securing means, e.g., ties, straps, etc., or by weaving the cables through a lattice/grid structure. Cables organized in this manner generally bunch together relative to the articulating members and impede airflow from the back of the server. Indeed, cables organized using conventional arms typically stack in a vertical plane parallel to the rear of the server This vertical stacking results in a large surface area blocking exhausting air flow.

These and other deficiencies/needs are addressed by the systems and methods of the present disclosure.

### SUMMARY

The systems and methods disclosed herein generally involve an extensible articulated arm for stacking/organizing cables in-line with an exhausting airflow, e.g., from the rear of a server. The articulated arm typically includes a series of hindgedly connected elongated members. In exemplary embodiments, the articulated arm is mounted, using a mounting element, relative to a structure near an exhausting airflow, e.g., relative to a cabinet enclosure for the server. An elongated cable management conduit may be secured relative to each elongated member, wherein the elongated cable management conduit defines an elongated channel adapted for receiving one or more cables therethrough. Each elongated cable management conduit is typically configured such that the width of the cable management conduit is greater than its height. Thus, cables/cords received through the elongated channel of the cable management conduit may be arranged within the elongated channel relative to a plane in-line with the exhausting airflow. For typical airflow from the back of a server, this arrangement means that the cables/cords are aligned relative to a horizontal plane (as contrasted with the vertical or bunched cable arrangements of traditional cable management arms). In exemplary embodiments, the elongated cable management conduits are configured and shaped like elliptic cylinders. This aerodynamic design enables the cable management conduits to act as airfoils, thus promoting efficient airflow of exhausting air around the cable management conduits.

Methods disclosed herein generally involve mounting the extensible articulated arm relative to an enclosure and running one or more cables/cords through the elongated channels of the elongated cable management conduits associated with extensible articulated arm.

Additional features, functions and benefits of the disclosed systems and methods will be apparent from the description which follows, particularly when read in conjunction with the appended figures.

### BRIEF DESCRIPTION OF THE DRAWINGS

To assist those of ordinary skill in the art in making and using the disclosed assemblies and methods, reference is made to the appended figures, wherein:

FIG. 1 is a perspective view of an exemplary cable management system, including an extensible articulated arm, a plurality of elongated cable management conduits, and a mounting element, wherein the articulated arm is in an extended position.

FIG. 2 is a perspective view of the exemplary cable management system of FIG. 1, wherein the articulated arm is in a retracted position.

FIG. 3 is a perspective view of an exemplary mounting element adapted for mounting relative to finger detail.

FIG. 4 is a cut view of an exemplary elongated cable management conduit.

### DESCRIPTION OF EXEMPLARY EMBODIMENT(S)

According to the present disclosure, advantageous systems and methods are provided for facilitating cable management. More particularly, the disclosed systems and methods generally involve an extensible articulated cable management arm. The cable management arm may advantageously be associated with a plurality of elongated cable management conduits configured for grouping, arranging and routing cables/cords, e.g., power cables, relative thereto.

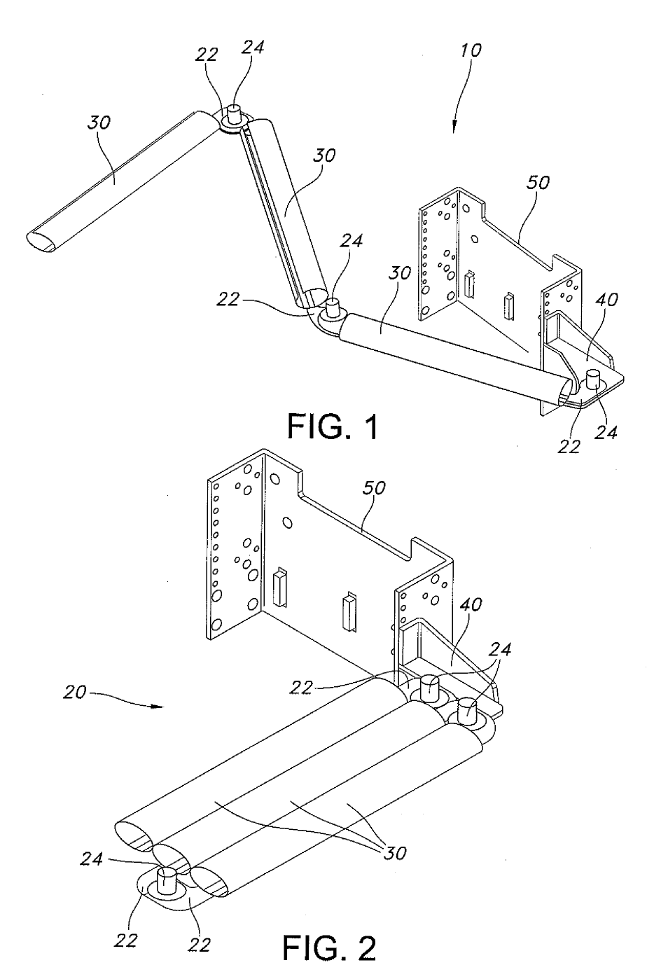

With initial reference to FIGS. 1 and 2, an exemplary cable management system 10 is depicted. The cable management system 10 generally includes an articulated arm 20, a plurality of elongated cable management conduits 30, and a mounting element 40. The articulated arm 20 may include a plurality of elongated members 22 pivotally connected in series, e.g., by means of pivots 24. Thus, the articulated arm 20 is adapted for movement between extended (FIG. 1) and retracted (FIG. 2) positions. It is noted that the number of elongated members 22 and the length of each elongated member 22 may advantageously be selected to establish a desired extended and/or collapsed configuration. Thus, the articulated arm 20 may be tailored for a particular cabinet enclosure. In exemplary embodiments, a plurality of extensible arms 20 may be interconnected, e.g., using double lever joints.

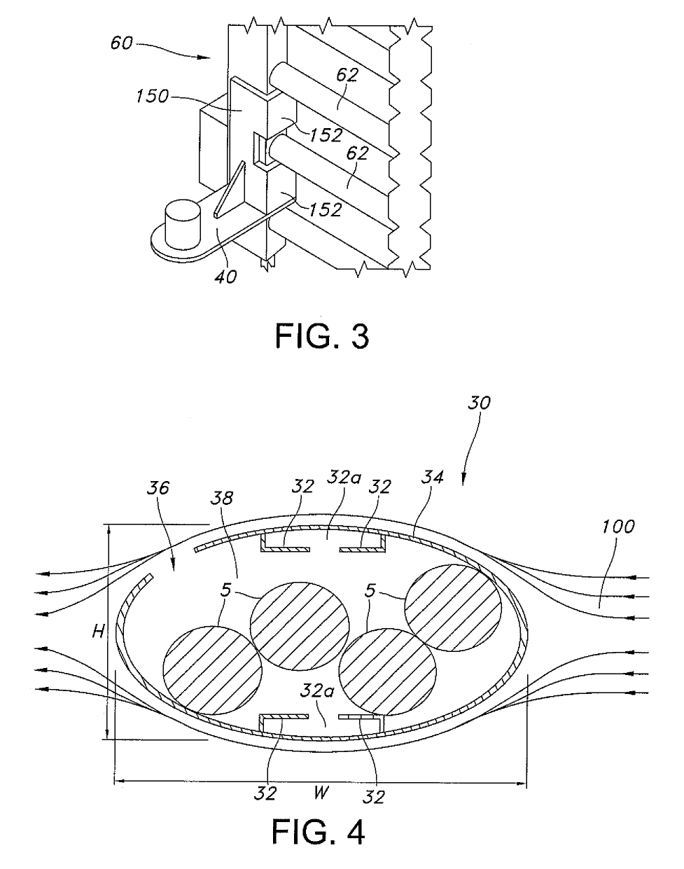

The disclosed cable management system 10 may typically be mounted relative to a structure near an exhausting airflow, e.g., a server enclosure, by means of the mounting element 40. Thus, the mounting element 40 may, e.g., be secured to an EIA rack upright 50 of a server enclosure. The mounting element 40 is typically configured and dimensioned to correspond to the structure to which the cable management system 10 is being mounted. Thus, the mounting element 40 depicted in FIGS. 1 and 2 is configured for mounting relative to an EIA rack upright 50 of a server enclosure. In exemplary embodiments, the mounting element 40 may include a mounting bracket configured for association with a mounting surface. The mounting bracket may be integrally formed as part of the mounting element 40 (see, e.g., FIGS. 1 and 2). Alternatively, the mounting element 40 may be associated with one or more interchangeable mounting brackets (not depicted) for facilitating mounting the cable management system 10 relative to a variety of structures. Referring now to FIG. 3, a mounting element 40 is depicted including an integrally formed mounting bracket 150. The mounting bracket 150 portion of the mounting element 40 includes a plurality of flanges 152 configured to correspond to vertical finger details 62 of a structure 60.

In exemplary embodiments, the cable management system 10 of FIGS. 1 and 2 includes an elongated cable management conduit 30 mounted relative to each elongated member 22. Each elongated cable management conduit 30 generally defines an elongated channel for receipt of one or more cables (not depicted) therethrough. The elongated cable management conduits 30 and elongated members 22 are typically configured and dimensioned so as to promote a desirable cable bend radius around the pivots 24, e.g., when the articulated arm 20 is in a retracted state. Thus, the pivots 24 may include shaft elements for guiding the cables/cords therearound. Each shaft element may have a large enough radius to promote desirable cable bend.

Referring now to FIG. 4, a cut view of an exemplary elongated cable management conduit 30 is depicted. The elongated cable management conduit includes a shell 34 defining an elongated channel 38 for receipt of cables 5 therethrough. The cables 5 are inserted into the elongated channel 38 by means of a slit 36 in the shell 34. The elongated cable management conduit 30 typically extrudes one or more fasteners 32 for securing the elongated cable management conduit 30 relative to an elongated member.

For example, FIG. 4 depicts a plurality of fasteners 32 defining top and bottom slots 32A adapted for receipt of an elongated member therethrough. The inclusion of a plurality of slots 32A advantageously allows the orientation of the elongated cable management conduit to be adjusted relative to an elongated member. It is noted that fastener configurations different than that depicted in FIG. 4 may be utilized. For example, various other connection means, e.g., tacks, clips, Velcro, etc., may be employed. It is further noted that, while the inclusion of the fasteners 32 on the interior of the shell 34 offers particular advantages, as noted herein, the fasteners 32 may likewise be positioned relative to the exterior of the shell 34. In exemplary embodiments, the fasteners 32 may include a swivel mechanism for allowing the elongated cable management conduit 30 to swivel relative to an elongated member. This swiveling capability may advantageously facilitate orienting the elongated cable management conduit 30, e.g., for easy cable/cord insertion and extraction.

As depicted in FIG. 4, the elongated cable management conduit 30 is advantageously configured and oriented so to not impede exhausting airflow 100 from a server. Thus, the elongated cable management conduit 30 is typically configured such the width w of the elongated cable management conduit 30 is greater than the height h of the elongated cable management conduit 30. In exemplary embodiments, the height “h” is 1U or less. Thus, by accommodating the volume of cables 5 through an increased horizontal width (in-line with the airflow) and by minimizing the vertical height “h” (perpendicular to the airflow), the obstruction of the airflow 100 is advantageously minimized.

Referring to the embodiment depicted in FIG. 4, the cables 5 are arranged within the elongated channel 38 relative to a horizontal plane in-line with a horizontal airflow 100. Note, however, that the particular configuration and orientation of the elongated cable management conduit 30 in FIG. 4 is not limiting. Indeed, the optimal configuration and orientation of the elongated cable management conduit 30 generally depends on the actual direction of the airflow 100. For example, a vertical airflow would require a vertical alignment of the cables 5, etc.

In exemplary embodiments, the elongated cable management conduit 30 is configured and shaped like an elliptic cylinder. This aerodynamic design enables the cable management conduit 30 to function similar to an airfoil in promoting the airflow 100 of exhausting air around the elongated cable management conduit 30. Thus, the fasteners 32, depicted in FIG. 4, are included on the interior of the shell 34. The smooth outer surface of the shell 34 promotes unrestricted airflow 100 therearound.

Although the present disclosure has been described with reference to exemplary embodiments and implementations thereof, the disclosed systems and methods are not limited to such exemplary embodiments/implementations. Rather, as will be readily apparent to persons skilled in the art from the description provided herein, the disclosed systems and methods are susceptible to modifications, alterations and enhancements without departing from the spirit or scope of the present disclosure. Accordingly, the present disclosure expressly encompasses all such modifications, alterations and enhancements within the scope hereof.

What is claimed:

1. A cable management system, comprising:
(a) an extensible articulated arm having a plurality of elongated members including a first elongated member and one or more successive elongated members, each of said one or more successive elongated members pivotally connected relative to a preceding elongated member by means of a pivot;
(b) a mounting element adapted for mounting said arm relative to a structure, wherein said first elongated member is pivotally connected relative to said mounting element; and
(c) a plurality of elongated cable management conduits, each elongated cable management conduit defining an elongated channel configured and dimensioned for receiving one or more cables or cords therethrough, wherein each elongated cable management conduit is adapted for mounting relative to one of the elongated members.

2. The cable management system of claim 1, wherein the elongated cable management conduit is characterized by a height of less than 1U.

3. The cable management system of claim 1, wherein the width of the elongated cable management conduit is greater than the height of the elongated cable management conduit.

4. The cable management system of claim 3, wherein each of the elongated cable management conduits is oriented such that the width of the elongated cable management conduit is in-line with an exhausting airflow.

5. The cable management system of claim 1, wherein each of the elongated cable management conduits facilitates arrangement of the one or more cables or cords relative to a plane in-line with an exhausting airflow.

6. The cable management system of claim 1, wherein each of the elongated cable management conduits is shaped as an elliptic cylinder.

7. The cable management system of claim 1, wherein each of the elongated cable management conduits is configured and dimensioned to function as an airfoil in facilitating airflow around the elongated cable management conduit.

8. The cable management system of claim 1, wherein each of the elongated cable management conduits is mounted relative to one of the plurality of elongated members by attachment means on the interior of the elongated cable management conduit.

9. The cable management system of claim 1, further comprising a plurality of interconnected extensible articulated arms.

10. The cable management system of claim 1, further comprising a mounting bracket that is either: (i) associated with the mounting element, or (ii) integrally formed with the mounting element.

11. The cable management system of claim 1, further comprising a plurality of interchangeable mounting brackets for facilitating mounting of the articulated arm relative to any of a variety of structures.

12. The cable management system of claim 1, wherein the pivots are configured to promote a predetermined minimum bend radius for the one or more cables or cords.

13. The cable management system of claim 1, wherein each of the elongated cable management conduits is adapted to swivel relative to the elongated member to which it is mounted.

14. A method for facilitating cable management for a server said method comprising the steps of:
(a) mounting an extensible articulated arm relative to a structure using a mounting element, said articulated extendible arm having a plurality of elongated members including a first elongated member and one or more successive elongated members, each of said one or more successive elongated member pivotally connected relative to a preceding elongated member by means of a pivot, wherein the first elongated member is pivotally connected relative to the mounting element, and wherein an elongated cable management conduit defining an elongated channel adapted for receiving one or more cables or cords therethrough is mounted relative to each elongated member; and
(b) running one or more cables or cords through the elongated channels of the elongated members.

15. The method claim 14, wherein the elongated cable management conduit is characterized by a height of less than 1U.

16. The method of claim 14, wherein the width of the elongated cable management conduit is greater than the height of the elongated cable management conduit.

17. The method of claim 16, wherein each of the elongated cable management conduits is oriented such that the width of the elongated cable management conduit is in-line with an exhausting airflow.

18. The method of claim 14, wherein the one or more cables are arranged relative to a plane in-line with an exhausting airflow.

19. The method of claim 14, wherein each of the elongated cable management conduits is shaped as an elliptic cylinder.

20. The method of claim 19, wherein each of the elongated cable management conduits is aligned to function as an airfoil in facilitating airflow around the elongated cable management conduit.
